(19) United States
(12) Patent Application Publication
(10) Pub. No.: US 2019/0001604 A1
(43) Pub. Date: Jan. 3, 2019

(54) METHOD AND APPARATUS FOR FORMING A PRODUCT PACKAGE BOX AND A PRODUCT PACKAGE BOX

(71) Applicant: OY JOPAMAC AB, Forssa (FI)

(72) Inventor: Jouni Suokas, Tammela (FI)

(21) Appl. No.: 16/064,752

(22) PCT Filed: Dec. 21, 2016
(86) PCT No.: PCT/FI2016/050910

§ 371 Date: Jun. 21, 2018

(30) Foreign Application Priority Data
Dec. 23, 2015 (FI) 20156011
Jan. 26, 2016 (FI) 20165047

(51) Int. Cl. B31B 50/04; B65D 5/12; B65D 5/54; B31B 50/20

(52) U.S. Cl. CPC B31B 50/046; B65D 5/12; B31B 50/60; B31B 50/20; B65D 5/541

(57) ABSTRACT

The object of the disclosure is a method and an apparatus for mechanically forming a product package box. According to the disclosure, a product package box is formed with a box-forming apparatus from a tubular sleeve folded flat, which sleeve is mechanically opened into the correct shape of the product package box and to which is affixed an essentially integral base panel. On the basis of online data coming from a picking system, for each product package box, a sleeve is selected from a sleeve bundle, the height of which sleeve corresponds most suitably to the online data, or a sleeve of suitable height is cut from a sleeve blank.

### CROSS-REFERENCE TO RELATED APPLICATIONS

This application is a national phase entry under 35 U.S.C. § 371 of International Patent Application PCT/FI2016/050910, filed Dec. 21, 2016, designating the United States of America and published in English as International Patent Publication WO 2017/109289 A1 on Jun. 29, 2017, which claims the benefit under Article 8 of the Patent Cooperation Treaty to Finnish Patent Application Serial Nos. 20165047, filed Jan. 26, 2016, and 20156011, filed Dec. 23, 2015.

### TECHNICAL FIELD

The object of the disclosure is a method as specified in the preamble of claim 1 and an apparatus as specified in the preamble of claim 8 for forming a product package box, and also a product package box as specified in the preamble of claim 15.

### BACKGROUND

The method and apparatus according to the disclosure, hereinafter more briefly the solution according to the disclosure, relates to a product package box mechanically fabricated, preferably from recyclable fiber material, for each specific order, e.g., in conjunction with a picking system in shipping departments. In this case one preferred option for material is corrugated board and/or some other suitable recyclable fiber material.

According to what is known in the art, product package boxes are generally fabricated from box blanks, the first and last side of which are glued together at their vertical edge, and which blanks also comprise flaps forming a base and a lid. In these solutions a corrugated board mill, for example, produces the raw material for boxes, which is delivered to a separate processing phase in which box blanks are fabricated from the corrugated board by cutting the raw material received into panels of the right size and shape, and by providing the box blanks with the necessary fold lines and folding the blanks into the shape of a box, as well as by gluing them into semifinished boxes, which are finally flattened and stacked one on top of another into bundles and are delivered as bundles to the next processing phase, i.e., to the forming of a final product package box, e.g., in the product picking and shipping stage.

One of the most widely used product package boxes according to what is known in the art is the four-flap regular slotted container, known also by the code FEFCO 0201. A problem in this solution is that a pre-assembled product package box has an overlapping double layer of corrugated board in a large part of the lid structure and base structure. In some cases, such as in boxes according to code FEFCO 0203, there are even four layers of corrugated board, one on top of another. More corrugated board is needed as a consequence of this overlapping of material, which makes a product package box more expensive while also reducing the useful volume of the inside space of the box. Another drawback is the inflexibility of the prior art in fabricating in an optimized manner product package boxes that are as far as possible of the correct height with regard to the product or product batch being packed. This inflexibility raises packing material costs and also shipping costs. Furthermore, a drawback in glued or taped lid structures according to prior art is that a tool, such as a knife or scissors, is often needed for opening the lid.

### BRIEF SUMMARY

The aim of the present disclosure is to eliminate the aforementioned drawbacks and to provide an inexpensive, reliable, fast, flexible and cost-efficient method and apparatus for fabricating a product package box. Another aim of the disclosure is to provide a method and an apparatus with which product package boxes can be formed that have a minimum amount of overlapping material layers, or none at all, taking up expensive package space. A further aim is provide a product package box taking up as little space as possible, having a lid that is easily openable without separate tools. The method according to the disclosure is characterized by what is disclosed in the characterization part of claim 1. Correspondingly, the apparatus according to the disclosure is characterized by what is disclosed in the characterization part of claim 8, and the product package box according to the disclosure is characterized by what is disclosed in the characterization part of claim 15. Other embodiments of the disclosure are characterized by what is disclosed in the other claims.

In the method according to the disclosure for mechanically forming a product package box, the product package box is formed with a box-forming apparatus from a tubular sleeve folded flat, which sleeve is opened mechanically into the correct shape for a product package box and to which sleeve an essentially integral base panel is affixed. On the basis of online data coming from the picking system, for each product package box a sleeve is selected from a sleeve bundle, the height of which sleeve corresponds most suitably to the online data or a sleeve of suitable height is cut from a sleeve blank. Flattening the foldable fastening flaps of the base panel and of the lid panel before fastening them to the box frame provides a geometrically straight package box that is optimized in terms of its outer dimensions. In a solution according to one preferred embodiment of the disclosure, a tear strip is glued to the top edge of the frame of the product package box, which tear strip remains below the flaps of the lid panel that are folded over the frame and are affixed, e.g., by gluing, to the frame. The end of the tear strip on a part of one corner of the package box comes essentially out and into view so that a good grip can be obtained on it with a finger when opening the package box.

The apparatus according to the disclosure for forming a product package box provided with a base in a picking system comprises at least a box-forming apparatus, a feeder line for feeding material into the box-forming apparatus and an output line, as well as a plurality of actuators for forming the product package box. For each product package box the apparatus is arranged, on the basis of online data coming from the picking system, either to select a sleeve from a sleeve bundle, the height of which sleeve corresponds most suitably to the online data, or to form a sleeve cut to a suitable height from a sleeve blank.

Preferably, the apparatus according to the disclosure for forming a product package box provided with a base comprises at least a box-forming line provided with actuator means for opening a sleeve functioning as a box frame and folded flat into a box blank of essentially regular shape, and actuator means for affixing a base panel to the opened box blank, as well as actuator means for transferring a product package box provided with a base panel out of the box-forming apparatus.

One advantageous solution is that prefabricated sleeves corresponding to product package boxes of different heights are used for forming a product package box, based on online data and depending on the height of the product to be packed. Another advantageous solution is that sleeves of suitable height are cut in an optimized way based on online data from flattened sleeve blanks, from each of which sleeve blanks sleeves of different heights can be cut.

One advantage, among others, of the method and apparatus according to the disclosure, as well as of the product package box, these being more briefly described in other words as the solution according to the disclosure, is that packaging material is saved with the solution according to the disclosure because the base structure and lid structure can be made to be simple and using thinner and less expensive material than in the frame of the package. Another advantage is that thin and simple base structures and lid structures do not take from the packed product itself; valuable space inside a product package. A further advantage also is that the solution enables product packages that are as far as possible of the right height for the product to be flexibly made, whereby considerable savings can be made in material costs as well as in shipping costs. A further advantage is that a delivered product package box can be opened by means of the tear strip neatly and safely without separate tools, such as a knife or scissors.

### BRIEF DESCRIPTION OF THE DRAWINGS

In the following, the disclosure will be described in more detail by the aid of some examples of its embodiment with reference to the accompanying simplified drawings, wherein:

FIG. 1 presents one basic principle used in the solution according to the disclosure for fabricating a product package box closed at the base, as viewed obliquely from the side and from above;

FIG. 2 presents a simplified view of one apparatus according to the disclosure, as seen obliquely from the side and from above, with which apparatus product package boxes of a number of heights are fabricated for further processing;

FIG. 3 presents one method, as viewed obliquely from the side and from above, used in the solution according to the disclosure for fabricating product package boxes of different heights;

FIG. 4 presents another method, as viewed obliquely from the side and from above, used in the solution according to the disclosure for fabricating product package boxes of different heights;

FIG. 5 presents one additional property according to the disclosure for the method presented by FIG. 4;

FIG. 6 presents a simplified and partly magnified view of one product package box according to the disclosure, as seen obliquely from the side and from above, on which box a lid structure for the product package box has been formed;

FIG. 7 presents a simplified and partly magnified view of another product package box according to the disclosure, as seen obliquely from the side and from above, wherein a tear strip has been formed on the lid structure for opening the lid without tools; and

FIG. 8 presents a simplified view of a product package box according to the disclosure, as seen obliquely from the side and from above, after being opened without tools by means of the tear strip.

### DETAILED DESCRIPTION

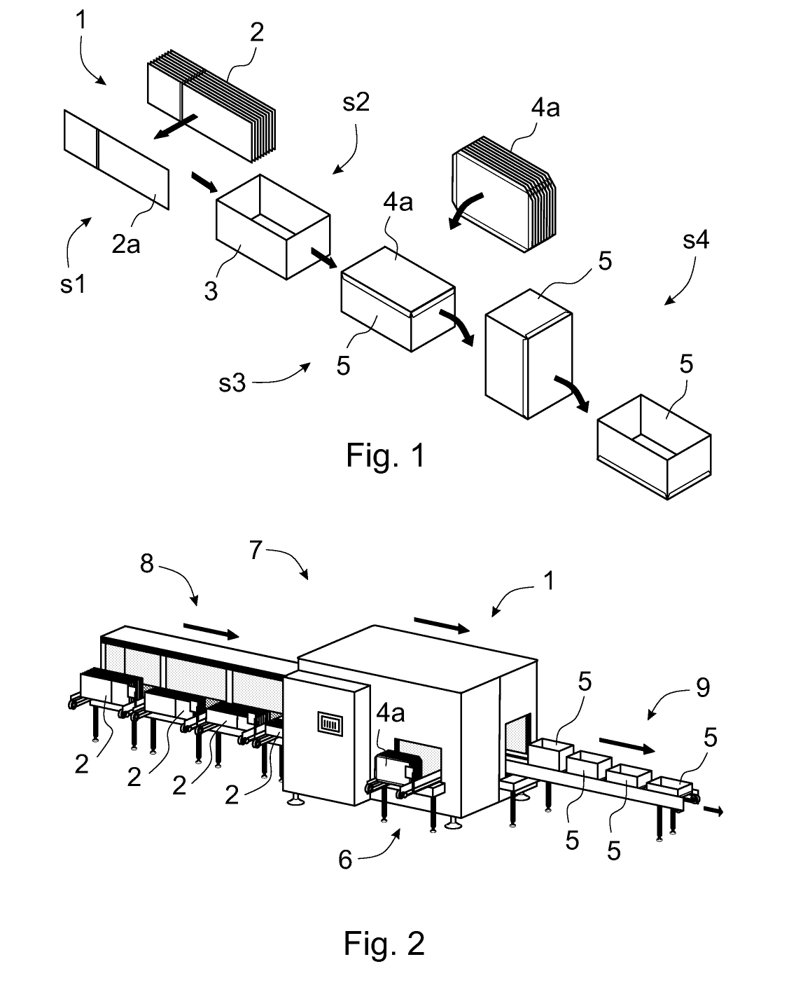

FIG. 1 presents a simplified diagram of the different phases of one method according to the disclosure, which method is realizable, e.g., with the apparatus according to FIG. 2. The apparatus according to the disclosure is disposed, e.g., in connection with or in the proximity of a picking warehouse and/or shipping department, so that each order-specific product package box 5 needed is quickly formable and available for packaging use at any given time.

Sleeves 2a fabricated, e.g., from corrugated board and/or from some other suitable recyclable fiber material by folding-gluing or by some other method, fastened into a tubular shape and functioning as a box frame, and then folded flat, which sleeves comprise the side walls and end walls of the product package box to be fabricated, but not the base panel or lid panel, are fed in the first phase s1 of the method into the start end of the box-forming line 1 of the box-forming apparatus 7 belonging to the apparatus, preferably from a bundle or stack 2 of sleeves, the bundle or stack being situated in the proximity of the start end of the box-forming line 1. In this case, an individual folded-flat sleeve 2a is separated from the sleeve bundle 2, which sleeve is opened in the next phase s2 on the box-forming line 1 to become a box blank 3 forming the frame of a box, into the essentially regular shape of a product package box enabled by the size and shape of the sleeve, and is transferred onwards on the line. An individual sleeve 2a is, e.g., a frame according to code FEFCO 0501 that is folded flat.

A space 6, e.g., for the bundled or stacked base panels 4a of product package boxes, is also provided in connection with the box-forming line 1, as well as actuators for affixing base panels 4a to a box blank 3 in the box-blank fastening phase. In this case, in the next phase s3 of the method, one base panel 4a at a time is taken from the base panel bundle with the aforementioned actuators and is affixed, e.g., by taping or gluing, to the upward-pointing edge of the box blank 3 forming the frame of the box, thus becoming the base of the product package box. After this, the product package box 5 provided with a base is turned, with a suitable actuator, base side downwards in phase s4, after which the product package box 5 is ready as an unlidded product package box for further processing in product packaging and box closing.

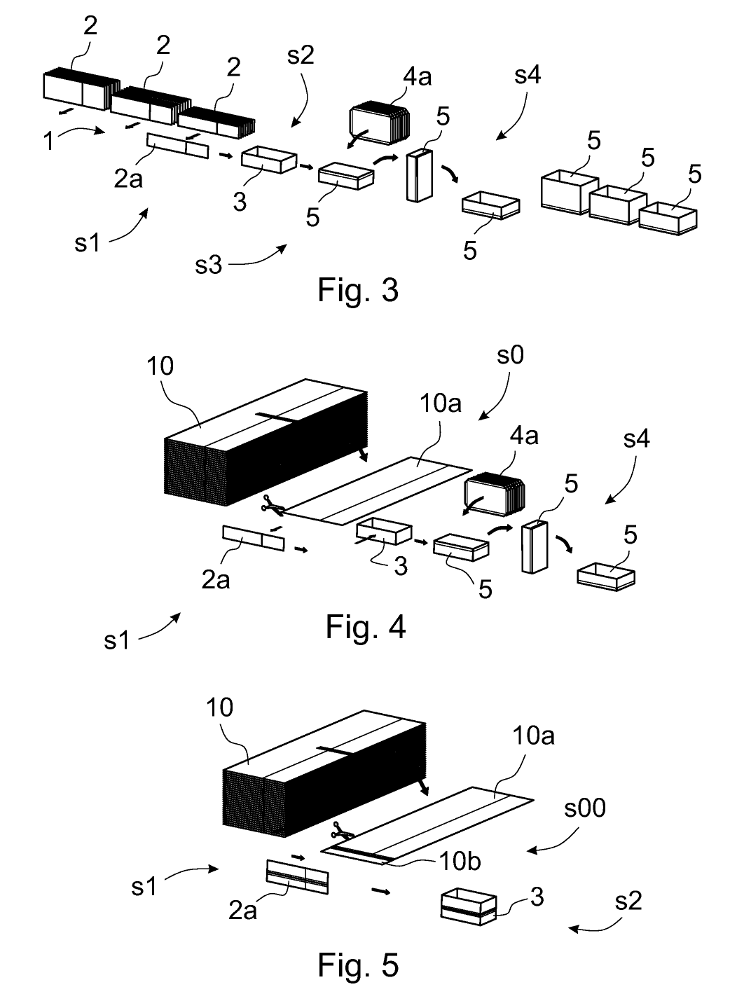

FIG. 2 presents one apparatus to be used in the solution according to the disclosure and FIG. 3 presents the different phases of one method according to the disclosure, which method is realizable with the apparatus according to FIG. 2. The apparatus according to FIG. 2 and the method according to FIG. 3 function according to the basic method of FIG. 1. The apparatus according to the embodiment comprises at least one or more feeder lines 8 of folded-flat sleeves 2a. Preferably sleeve bundles 2 intended for forming product package boxes of different heights are loaded into connection with the feeder line 8, in which case a sleeve 2a that, according to an order-specific request coming to the apparatus, is always of suitable height for a product package box can be sent to the box-forming process.

A folded-flat sleeve 2a to be taken from the feeder line 8 to the box-forming process is transferred in phase s1 to the box-forming line 1 of the box-forming apparatus 7, where the sleeve 2a is opened in phase s2 into a box blank 3 and transferred onwards for affixing a base panel 4a to the box blank 3. When the box blank 3 is in phase s3 for affixing the base panel 4a, a suitable base panel 4a is separated from the base panel bundle and the base panel 4a is affixed, e.g., by taping or gluing, as already mentioned above, to the upward-pointing edge of the box blank 3 to become the base of the product package box. After this, the product package box 5 provided with a base is turned base side downwards in phase s4, after which the product package box 5 is transferred as a finished unlidded product package box to the output line 9 for further processing in product packaging and box closing.

With the apparatus according to FIG. 2 and with the method according to FIG. 3 associated with it, product package boxes 5 of a number of heights can be made to order, depending on what heights the products are that will be packed in the boxes in downstream processing.

FIGS. 4 and 5 present another method according to the disclosure, which method is based on the basic method presented by FIG. 1. The method according to FIG. 4 and the apparatus associated with it are otherwise similar to the method according to FIG. 1 and the apparatus according to FIG. 2, but in this solution sleeves 2a pre-cut to the final height of a box are not used, but instead sleeves are cut based on the specific order to exactly the right widths to correspond to the correct height of the final product package box 5.

In this solution in the proximity of the start end of the box-forming line 1 (FIGS. 1 and 2), in a stack or bundle 10, are long sleeve blanks 10a corresponding to the height of more than one product package box 5, fabricated by folding-gluing or otherwise and then folded flat, from each of which sleeve blanks 10a a number of order-specific sleeves 2a are cut according to the order. At the start of the box-forming process one sleeve blank 10a at a time is separated from the bundle 10 for processing on the cutting table of the apparatus, where in phase s0 a sleeve 2a of the correct height, corresponding to the product to be packed, is cut for the specific order in an optimized manner from the sleeve blank 10a with the cutting device belonging to the apparatus. Cutting can be implemented in the apparatus, e.g., by laser cutting or by guillotine cutting.

With regard to the functions after cutting, the box-forming apparatus 7, and associated box-forming line 1, of the apparatus is essentially similar to what is specified in the solutions presented by FIGS. 2 and 3. In this case a cut and folded-flat sleeve 2a is opened on the box-forming line 1 in phase s2 into a box blank 3 and transferred onwards on the line to the phase s3 for affixing a base panel 4a and then onwards via phase s4 to the output line 9, as presented in the solution according to FIGS. 2 and 3.

FIG. 5 presents a solution wherein the last sleeve piece 10b of the sleeve blank 10a cut in the method according to the solution presented by FIG. 4 is efficiently utilized, which sleeve piece could otherwise be rejected if it did not correspond as such to a suitable order-specific height of a product package box. According to the method, the last sleeve piece 10b remaining from the previous sleeve blank 10a is affixed in phase s00, before the cutting of the next sleeve 2a, to the start of a new sleeve blank 10a, e.g., by taping, with adhesive paper, by gluing, by stapling or with some other suitable fastening method. The first sleeve 2a cut in this way from a continued sleeve blank 10a thus comprises one extension in the height direction of the product package box to be formed, which does not, however, impair the durability properties of the finished product package box 5, but brings cost savings in packaging material.

For selecting a sleeve 2a of as far as possible the correct height from a sleeve stack 2 or for cutting a sleeve from a sleeve blank 10a, the apparatus according to the disclosure is provided with means for receiving order-specific data, by the aid of which means continuous order data and/or control data, i.e., online data, is received from the picking system about the properties needed for the product package box 5 being formed, such as, e.g., about the height of the product package box 5 needed at any given time.

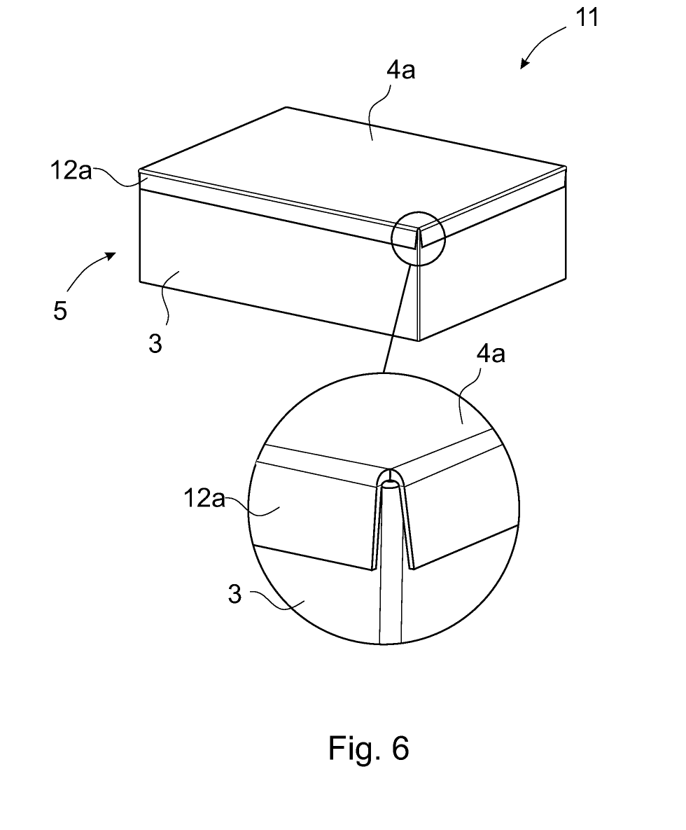

FIG. 6 presents a simplified view, as seen obliquely from the side and from above, of one base and lid structure 11 of a product package box 5 formed with the method according to the disclosure. An essentially integral base panel 4a is affixed to the box blank, i.e., to the package box frame 3, in such a way that the fastening flaps 12a of the base panel 4a are first flattened, i.e., compressed to be thinner, after which they are bent on top of the frame 3 of the package box 5 and glued by their inner surface attached to the outer surface of the frame 3.

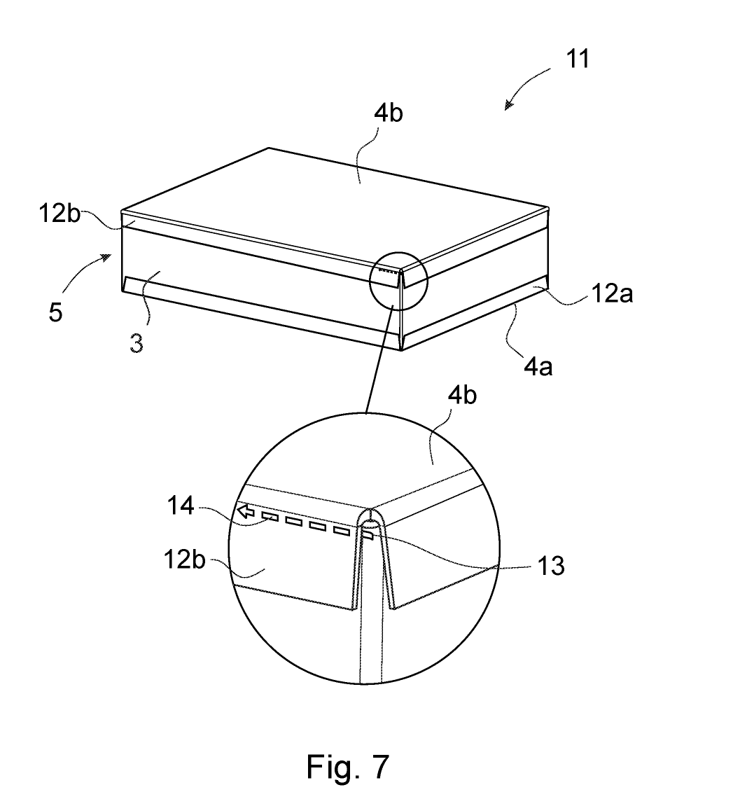

FIG. 7 presents one solution according to the disclosure wherein a tear strip 13 circling the whole box frame 3 is affixed, e.g., by gluing, to the top edge of a product package box 5, to the outer surface of the box frame 3 in such a way that the other end of the tear strip 13 comes suitably out from one corner of the frame of the product package box 5. On the flap 12b of the lid panel 4b of the package box is a printed or impressed instruction 14 for opening the lid 4b by means of the tear strip 13. Correspondingly, a tear strip 13 can also be glued to the bottom edge of the product package box 5, whereby also the base panel 4a of a package box is detachable by means of a tear strip 13, correspondingly to the lid panel 4b of the package box. A tear strip 13 can also be affixed to the inside surface of the flattened flaps 12a, 12b, which inside surface is glued in the forming phase of the package box to the outer surface of the box frame 3. In this case each side flap and end flap has its own tear strip 13. Preferably the lid panel 4b is essentially similar to the base panel 4a.

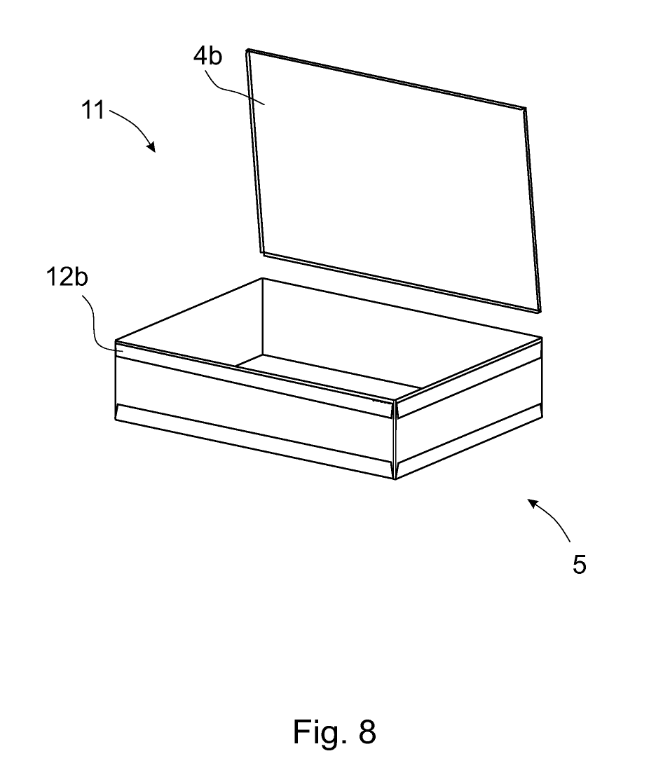

FIG. 8 illustrates how the lid panel 4b detaches easily from the frame 3 of the product package box 5 by means of the tear strip 13. After opening the tear strip 13 of the lid panel 4b, only the glued and flattened flaps 12b of the lid panel 4b remain attached to the frame 3 of the product package box 5.

In a solution according to one preferred embodiment of the disclosure, a tear strip 13 is affixed to only three sides of the frame 3 of a product package box 5, in which case, e.g., the tear strip 13 is between only three flaps 12b of the lid panel 4b and the box frame 3. In such a case the flap 12b under which there is no tear strip 13 stays glued and attached to the box frame 3 and functions just like a hinge when the lid panel 4b is opened using the tear strips 13 of the three sides. A lid panel 4b hinged in this way can easily be re-closed and the product package box 5 can be re-used with a lid.

In this description of the solution according to the disclosure, the final stages of the packing process, such as packing the product in the product package box 5, are not presented. It can, however, be stated that it is advantageous to close a product package box 5 with a lid panel 4b that is essentially similar in its dimensions and in its material to the base panel 4a, in which case exactly the same methods and materials can be utilized for closing the product package box 5 as are used in conjunction with the base panel 4a of the box. The material of the base panel 4a and of the lid panel 4b can be the same material as the material of the sleeve 2a that is the box frame 3, but suitably it is essentially more advantageous in costs to have a thinner material than the material of the sleeve 2a.

As stated earlier, the lid panel 4b and base panel 4a of a product package box 5 are advantageously fabricated, e.g., from recyclable fiber material, particularly when the sleeve 2a that is the box frame 3 is made of recyclable fiber material. In this way delivering the whole product package box 5 to recycling after use is extremely easy. When a product package box 5 is provided with tear strips 13 for detaching both the lid panel 4b and the base panel 4a of the box, the product package box 5 is easily convertible after use into a bundle of recyclable fiber material taking up little space.

It is obvious to a person skilled in the art that the disclosure is not limited solely to the examples described above, but that it may be varied within the scope of the claims presented below. Thus, for example, some phases of the method can be in a different sequence than what is presented above and, in addition, some phases of the method can be absent and some phases of the method not presented can be included. Furthermore, some phases of the method can contain more or fewer functions than what is presented above.

It is also obvious to a person skilled in the art that the product package boxes made with the method can be different to what is presented above. The simplest and most common product package box is, however, of a rectangular shape, which is presented as an embodiment in all the figures. However, the shape of a package can be other than the rectangular-type shape of a box. Thus the shape can be, e.g., polygonal or also round or oval, depending on, e.g., the fold lines prefabricated in the sleeve blank.

It is further obvious to a person skilled in the art that the base panel of a product package box can be affixed in some other manner than by taping or gluing, e.g., the base panel can be affixed by means of kraft paper provided with glue, or when the base panel is provided with narrow flaps, as in the embodiments presented in the figures, the base panel is glued by its flaps to the outer surfaces of the box frame.

It is yet further obvious to a person skilled in the art that the product package boxes made with the method can be of some other material than recyclable fiber material. Thus, a product package box can be fabricated from some other foldable material than corrugated board. A product package box can be fabricated, e.g., from different boards, cardboards or papers or also from woven material, plastic or metal, or from combinations of different materials. The side walls of a box and the lid and also the base can be of the same material as each other or can also be of a different material.

1. A method of mechanically forming a product package box in a picking system, comprising:
forming the product package box with a box-forming apparatus from
a tubular sleeve folded flat, which tubular sleeve is mechanically opened into the correct shape of the product package box and to which is affixed an essentially integral base panel;
wherein, on the basis of online data coming from the picking system:
the tubular sleeve is selected from a sleeve bundle, the height of the tubular sleeve corresponding to the online data, or
the tubular sleeve is cut to the height from a sleeve blank.

2. The method according to claim 1, further comprising selecting prefabricated sleeves corresponding to product package boxes of different heights to form the product package box depending on a height of a product to be packed.

3. The method according to claim 1, further comprising:
selecting long sleeve blanks folded essentially flat and corresponding to the height of multiple product package boxes;
cutting the long sleeve blanks to form sleeve blanks exhibiting a height of the product package box before affixing the base panel to the tubular sleeve.

4. The method according to claim 3, wherein a last sleeve piece of a previous cut sleeve blank is affixed to a start of a new sleeve blank to be cut before, cutting of the new sleeve blank into separate tubular sleeves, and wherein the last sleeve piece is affixed to the start of the new sleeve blank to be cut, by taping, with adhesive paper, by gluing, by stapling or with another fastening method.

5. The method according to claim 1, wherein corrugated board is used as material of the tubular sleeve and the base panel, and/or wherein a lid panel provided with flaps made from at least essentially more advantageous material than the material of the tubular sleeve and is affixed to the tubular sleeve when the tubular sleeve has been opened into a box blank functioning as a frame of the product package box, and wherein the flaps of both the base panel and of the lid panel to be bent and fastened on top of the box blank are compressed to become thinner than a center part of the base panel and/or of the lid panel before fastening the flaps to the box blank.

6. The method according to claim 1, wherein one or more of the base panel and a lid panel are affixed to the tubular sleeve opened into a box blank by taping, with adhesive paper, by gluing, by stapling, or another fastening method.

7. The method according to claim 1, further comprising one or more of:
affixing a tear strip to a top edge of the product package box such that one end of the tear strip comes essentially out from one corner of a frame of the product package box and folded fastening flaps of a lid panel are folded on top of the tear strip and fastened to the product package box; and
fastening the tear strip to a bottom edge of the product package box such that one end of the tear strip comes essentially out from one corner of the frame of the product package box and the folded fastening flaps of the base panel are folded on top of the tear strip and fastened to the product package box, the tear strip being placed either between the frame of the product package box and at least three fastening flaps of one or more of the lid panel and the base panel.

8. An apparatus for forming a product package box provided with a base in a picking system, the apparatus comprising:
a box-forming apparatus;
a feeder line for feeding material into the box-forming apparatus;
an output line; and
a plurality of actuators for forming the product package box;
wherein, for each product package box, the apparatus is arranged, on the basis of online data coming from the picking system, either:
to select a sleeve from a sleeve bundle, the height of the sleeve corresponding corresponds most suitably to the online data, or
to cut the sleeve to the height from a sleeve blank.

9. The apparatus according to claim 8, further comprising:
a box-forming line with an actuator for opening a tubular sleeve folded flat and functioning as a box frame into a box blank of regular shape;
another actuator for affixing a base panel to the opened box blank; and
an additional actuator for transferring the product package box provided with the base panel out of the box-forming apparatus.

10. The apparatus according to claim 8, further comprising, in connection with the feeder line, a space for one or more sleeve bundles, each sleeve bundle having folded-flat sleeves corresponding to product package boxes of different heights.

11. The apparatus according to claim 8, further comprising:
in connection with the feeder line, a space for at least one sleeve blank bundle having sleeve blanks folded flat corresponding to a height of multiple product package boxes for cutting into a number of order-specific sleeves according to the order, and
a cutting device for cutting an order-specific sleeve from a sleeve blank and an actuator for transferring a cut sleeve to a forming line.

12. The apparatus according to claim 11, wherein the apparatus comprises actuator means for affixing a last sleeve piece of a previous cut sleeve blank to the start of a new sleeve blank to be cut, before the cutting of the new sleeve blank into separate sleeves.

13. The apparatus according to claim 8, further comprising, in connection with a box-forming line, a space for bundled or stacked base panels for product package boxes.

14. The apparatus according to claim 8, further comprising means for receiving order-specific data, the means arranged to receive one or more of continuous order data and control data from a picking system about properties for forming the product package box.

15. A product package box formed with the method according to claim 1, the product package box comprising:
a frame forming walls of the product package box;
a base panel affixed to the frame; and
folded fastening flaps on sides and ends of the base panel, a thickness of the folded fastening flaps smaller than a thickness of a center part of the base panel.

16. The product package box according to claim 15, further comprising:
a lid panel essentially similar to the base panel; and
additional folded fastening flaps on sides and ends of the lid panel, a thickness of the additional folded fastening flaps smaller than a thickness of a center part of the lid panel.

17. The product package box according to claim 16, further comprising one or more of:
on a top edge of the product package box, a tear strip between at least three of the folded fastening flaps of the lid panel and the frame of the product package box for at least partly detaching the lid panel from the box frame
on a bottom edge of the product package box another tear strip between at least three of the folded fastening flaps of the base panel and the frame of the product package box for at least partly detaching the base panel from the frame.
